(19) United States
(12) Patent Application Publication
(10) Pub. No.: US 2008/0096604 A1
(43) Pub. Date: Apr. 24, 2008

(54) Mobile Telephone Device

(75) Inventors: Yukari Yamazaki, Toyama (JP); Yutaka Saito, Ishikawa (JP); Yoshio Koyanagi, Kanagawa (JP); Kiyoshi Egawa, Tokyo (JP); Hiroyuki Sasaki, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/658,151

(22) PCT Filed: Jun. 22, 2005
(86) PCT No.: PCT/JP05/11422

§ 371 Date: Jan. 23, 2007

(30) Foreign Application Priority Data
Jul. 26, 2004 (JP) 2004-217903

(51) Int. Cl. H04M 1/00

(52) U.S. Cl. 455/553.1

(57) ABSTRACT

A mobile telephone device capable of acquiring a high sensitivity over a wide band without being obstructed by the antenna when in use and while being held by the hand of a user. In this device, a variable tuning circuit (106) and a band switching circuit (107) are connected with a loop element (104) acting as a TV receiving on-board antenna. The variable tuning circuit (106) is controlled with a tuning voltage (110) generated in a TV receiving circuit (109). A channel control unit (111) sets the received channel of the TV receiving circuit (109) and controls the band switching circuit (107) with a band switching signal (112).

### TECHNICAL FIELD

The present invention relates to a mobile telephone apparatus having a loop antenna element as a broadcast receiving antenna with broadcast receiving functions.

### BACKGROUND ART

As a receiving antenna for a mobile telephone apparatus equipped with a television receiving function, a dipole antenna comprised of a monopole antenna and a battery and arranged vertical with respect to a receiver (e.g., see patent document 1), is known.

As another receiving antenna for a mobile telephone apparatus of this type, a loop antenna that is mounted outside the case is known (e.g., see Patent Document 2).

Patent Document 1: Japanese Patent Application Laid-Open No. 2001-251131

Patent Document 2: Japanese Patent Application Laid-Open No. HEI10-084209

### DISCLOSURE OF INVENTION

### Problems to be Solved by the Invention

However, the conventional receiving antenna disclosed in Patent Document 1 has a problem that the sensibility to horizontally polarized waves, which is dominantly used as television waves, cannot be increased because the main polarized wave is vertically polarized waves.

The conventional receiving antenna disclosed in Patent Document 2 has problems that the loop antenna mounted outside the case may be cumbersome when used for a mobile telephone apparatus, and leads to inferior design.

It is an object of the present invention to provide a mobile telephone apparatus that has an antenna which is not cumbersome when in use and that can provide high sensibility over a wide frequency range while being held by a user in his/her hand.

### Means for Solving the Problem

A mobile telephone apparatus according to the present invention employs a configuration having: a broadcast receiving section that receives broadcasting; a loop antenna element built in a case of the mobile telephone apparatus; and a frequency control section that controls a resonant frequency of the loop antenna element according to a current receiving channel.

According to this configuration, the loop antenna element is built into the case of the mobile telephone apparatus, therefore the loop antenna element is not cumbersome when the mobile telephone apparatus is used. Moreover, in this configuration, high receiving sensitivity is provided over a wide frequency range because the frequency control section controls the resonant frequency of the loop antenna element corresponding to a current receiving channel.

### ADVANTAGEOUS EFFECT OF THE INVENTION

According to the present invention, the loop antenna element as a broadcast receiving antenna is built into the case of the mobile telephone apparatus, thereby providing an advantage that the loop antenna element is not cumbersome when the mobile telephone apparatus is used, and that the design of the phone improves. Moreover, according to the present invention, the resonant frequency of the loop antenna element is controlled, so that high receiving sensitivity can be obtained over a wide frequency range when the user is holding the mobile telephone apparatus in his/her hand and is viewing television broadcasting.

### BRIEF DESCRIPTION OF DRAWINGS

FIG. 1 shows a basic configuration of a mobile telephone apparatus according to a first embodiment of the present invention;

FIG. 2A is a side view showing a loop element of the mobile telephone apparatus according to the first embodiment of the present invention;

FIG. 2B is a front view showing the loop element of the mobile telephone apparatus according to the first embodiment of the present invention;

FIG. 2C is a plain view showing the loop element of the mobile telephone apparatus according to the first embodiment of the present invention;

FIG. 3 shows a state of use where the user is holding the mobile telephone apparatus according to the first embodiment of the present invention in his/her hand and viewing television broadcasting;

FIG. 4 shows a variable tuning circuit and a band switching circuit of the mobile telephone apparatus according to the first embodiment of the present invention;

FIG. 5 illustrates the operation of the variable tuning circuit and the band switching circuit of the mobile telephone apparatus according to the first embodiment of the present invention;

FIG. 6 shows a basic configuration of a mobile telephone apparatus according to a second embodiment of the present invention; and

FIG. 7 shows a variable tuning circuit and a band switching circuit of the mobile telephone apparatus according to the second embodiment of the present invention.

### BEST MODE FOR CARRYING OUT THE INVENTION

Embodiments of the present invention will now be described in detail below with reference to the accompanying drawings. In the drawings, like components of the same configurations or functions are assigned the same reference numerals and descriptions thereof will be omitted.

### First Embodiment

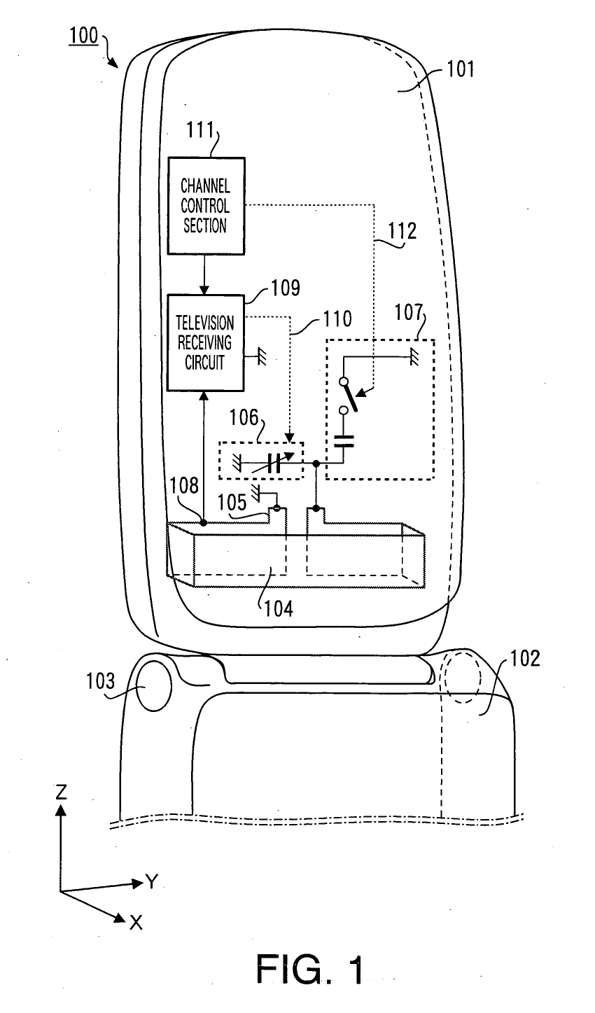

The mobile telephone apparatus according to the first embodiment of the present invention is described below with reference to FIGS. 1-5.

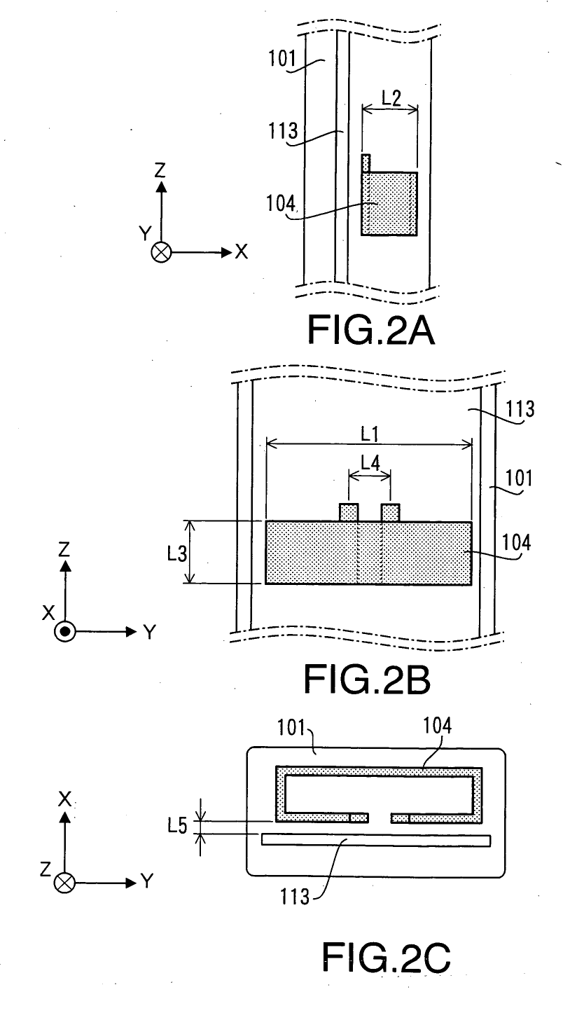

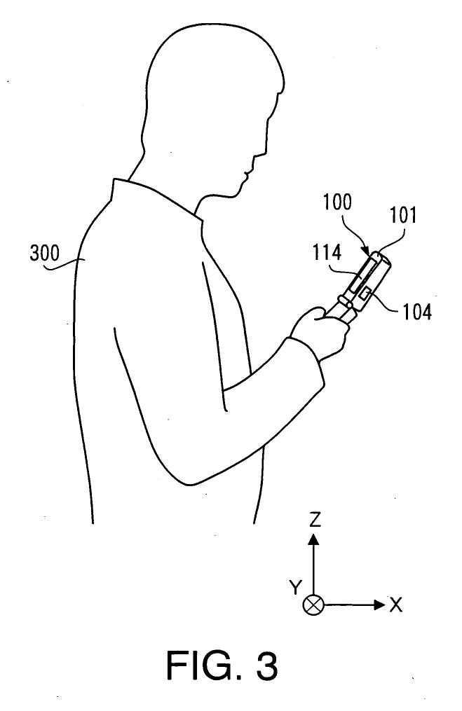

FIG. 1 shows a basic configuration of a mobile telephone apparatus according to a first embodiment of the present invention. FIG. 2A is a side view showing a loop element of the mobile telephone apparatus according to the first embodiment of the present invention, FIG. 2B is a front view of the loop element, and FIG. 2C is a plain view of the loop element. FIG. 3 shows a state of use where the user is holding the mobile telephone apparatus according to the first embodiment of the present invention in his/her hand and viewing television broadcasting.

As shown in FIG. 1, mobile telephone apparatus 100 according to the first embodiment is a foldable mobile telephone apparatus in which upper case 101 and lower case 102 are by hinge section 103 and are able to be opened and closed. Of course, the mobile telephone apparatus according to the present invention may be a straight-shaped mobile telephone apparatus comprised of one case.

Uppercase 101 and lower case 102 are made of molded insulating resin material. Loop element 104 as a loop antenna element is provided near hinge section 103 of upper case 101 along the width direction (Y-axis direction) of mobile telephone apparatus 100. Loop element 104 functions as a built-in television receiving antenna.

One end of loop element 104 is connected to the ground potential inside upper case 101 at ground section 105. To the other end of loop element 104, variable tuning circuit 106 as a variable tuning means and a frequency control means, and band switching circuit 107 as a frequency control means, are connected.

The resonant frequency of loop element 104 is controlled by variable tuning circuit 106 and band switching circuit 107 in the range between approximately 470 MHz and 700 MHz that are television broadcast frequencies.

Feed section 108 is provided a predetermined distance (e.g., approximately 10 mm) away from ground section 105 of loop element 104. The impedance of loop element 104 is tapped such that the impedance of feed section 108 becomes, for example, 50 ohms or 75 ohms.

Feed section 108 is connected to television receiving circuit 109, so that loop element 104 receives television waves. Television receiving circuit 109 generates tuning voltage 110 inside and using it controls variable tuning circuit 106. Channel control section 111 sets the receiving channel of television receiving circuit 109, and controls band switching circuit 107 using band switching signal 112.

Next, the configuration of loop element 104 will be described below with reference to FIG. 2A, FIG. 2B, and FIG. 2C. Loop element 104 is formed with, for example, a conductive plate that has a thickness of approximately 1 mm when folded and has a length in the width direction L1 of 40 mm, an element height L2 of 10 mm, and an element width L3 of 10 mm. The distance L4 between feeding sections of loop antenna 104 is set to be approximately 5 mm. This loop element 104 is fixed at a distance L5 of 2 mm to circuit substrate 113 provided in upper case 101.

The loop aperture plane of loop element 104 configured in this way is perpendicular to the plane of mobile telephone apparatus 100 (i.e., to circuit substrate 113). The ground pattern is typically placed all over the plane of circuit substrate 113. Therefore, the loop aperture plane of loop element 104 is perpendicular to the ground pattern (i.e., the grounding plane of mobile telephone apparatus 100).

Furthermore, the loop aperture plane of loop element 104 is positioned parallel to the width direction (Y-axis direction in FIG. 2) (i.e., the direction perpendicular to the longitudinal direction of mobile telephone apparatus 100).

Mobile telephone apparatus 100 according to the first embodiment is configured in the above manner, so that, as radiation characteristics of loop element 104, horizontally polarized wave characteristics can be achieved in parallel with the width direction of mobile telephone apparatus 100—that is, in the horizontal direction (Y axis direction) in the arrangement in FIG. 2.

Moreover, loop element 104 is positioned on an opposite plane to the plane where display section 114 of mobile telephone apparatus 100 shown in FIG. 3 is provided (that is, on the +X side plane in FIG. 2). With mobile telephone apparatus 100 according to the first embodiment configured in the above manner, loop element 104 has emission characteristics where higher antenna gain for horizontally polarized waves is obtained in the opposite plane to the plane where display section 114 is mounted.

Accordingly, when a user 300 is holding a mobile telephone apparatus 100 in his/her hand in front of his/her face and is viewing a television broadcast with display section 114 faced to his/her face as shown in FIG. 3, loop element 104 is located in front of the human body—that is, on the +X side—and therefore high antenna gain for a horizontally polarized waves is obtained in the front direction of the human body.

Furthermore, loop element 104 functions as a magnetic-field-mode antenna. In a range where the distance from the human body is less than about a 0.2 wavelength, radiation efficiency improves because the human body acts as a reflector and the radiation resistance increases due to the electromagnetic interaction with the human body. As a result, mobile telephone apparatus 100 according to the first embodiment provides an effect of increasing the gain in the vicinity of the human body, and, in this case, high receiving sensitivity is ensured.

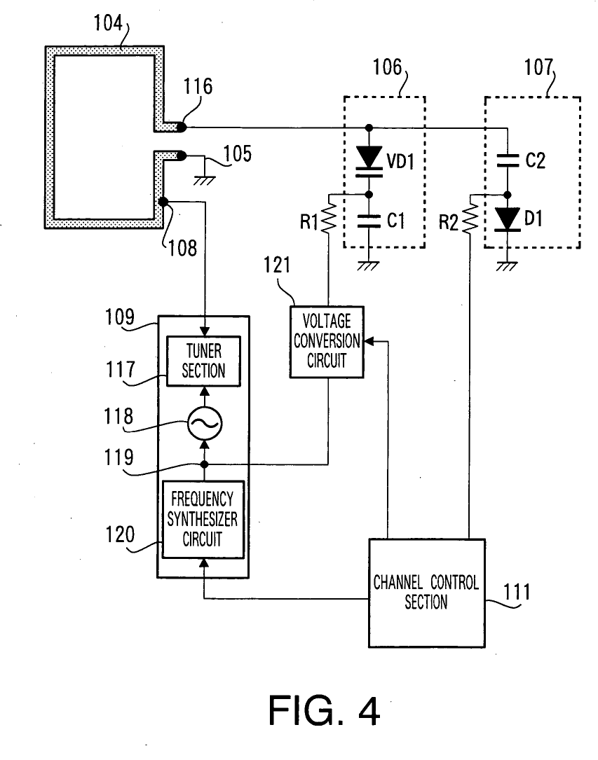

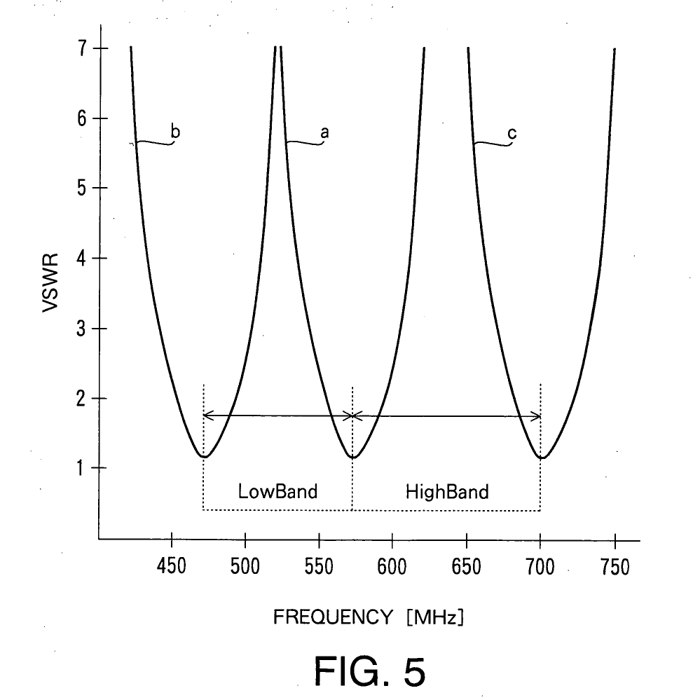

Next, the tuning of the resonant frequency of loop element 104 will be described below with reference to FIGS. 4 and 5. Loop element 104 functions as a very small loop antenna having a loop length of less than a 1/10 wavelengths in the range of 470 to 700 MHz of television broadcast frequencies, and has a relatively narrow operating bandwidth. For example, the bandwidth is about 10 MHz at 470 MHz, and the band ratio is about 1 to 2%.

FIG. 4 shows an example of variable tuning circuit 106 and band switching circuit 107. In this figure, variable tuning circuit 106 and band switching circuit 107 are connected to end section 116 to which ground section 105 of loop element 104 is not connected. Thus, variable tuning circuit 106 and band switching circuit 107 are serially connected to loop element 104 and the resonant frequency of loop element 104 is tuned to the television frequency band.

Variable tuning circuit 106 is comprised of a variable capacitance diode VD1 and a capacitor C1 that are serially connected. Tuning voltage 119 inside television receiving circuit 109 is applied to variable tuning circuit 106 as a reverse bias voltage of variable capacitance diode VD11 through voltage conversion circuit 121 and a resistor R1.

Band switching circuit 107 is comprised of capacitor C2 and PIN diode D1 that are serially connected. PIN diode D1 is switched by channel control section 111 by resistor R2.

Television receiving circuit 109 is comprised of tuner section 117 to which a received television signal from feed section 108 is input, and local oscillation circuit 118 that determines the receiving frequency at tuner section 117, and frequency synthesizer circuit 120. Frequency synthesizer circuit 120 is controlled by channel control section 111 and sets the oscillation frequency of local oscillation circuit 118, thereby setting the television receiving channel. Tuning voltage 119 changes from about 0.5 to 2.5V according to the receiving frequency of, for example, 470 to 700 MHz.

Next, the operation of variable tuning circuit 106 and band switching circuit 107 will be described below with reference to FIGS. 4 and 5.

When setting a receiving channel in HighBand (e.g. frequency of 570 to 700 MHz) shown in FIG. 5, channel control section 111 turns off the PIN diode D1 of band switching circuit 107. As a result, the capacitor C2 is not loaded invariable tuning circuit 106, and the resonant frequency of loop element 104 is set to change in the HighBand range.

In FIG. 4, the voltage conversion circuit 121 is a circuit that is comprised of an operational amplifier and performs voltage amplification, addition and subtraction. The coefficient for voltage conversion is controlled by setting of channel control section 111.

Specifically, when setting the receiving channel in the HighBand, voltage conversion circuit 121 is controlled by channel control section 111 and operates to convert changes from 1.5 to 2.5 V in tuning voltage 119 to changes from 0.5 to 2.5 V.

The capacitance of capacitor C1 is set such that the resonant frequency of loop element 104 determined by variable tuning circuit 106 changes (i.e., tracks) according to the television receiving channel. Specifically, the capacitance of capacitor C1 is selected in advance such that the VSWR characteristic designated by the code “a” in FIG. 5 is obtained when the reverse bias voltage of variable capacitance diode VD1 is 0.5 V, and the VSWR characteristic designated by the code “c” is obtained when the reverse bias voltage of variable capacitance diode VD1 is 2.5 V.

As a result, as shown in the HighBand range in FIG. 5, the resonant frequency of loop element 104 changes in the range of 570 to 700 MHz according to the receiving channel.

Next, when setting the receiving channel in the LowBand (e.g., frequency of 470 to 570 MHz) shown in FIG. 5, channel control section 111 turns on PIN diode D1 of band switching circuit 107. This allows capacitor C2 to be loaded in parallel to variable tuning circuit 106. As a result, the resonant frequency of loop element 104 is set to change in the LowBand range.

Specifically, in the LowBand, voltage conversion circuit 121 converts changes from 0.5 to 1.5 V in tuning voltage 119 to changes from 0.5 to 2.5 V. In addition, by adequately setting the capacitance value of capacitor C2, the VSWR characteristic designated by the code “b” in FIG. 5 is obtained when the reverse bias voltage of variable capacitance diode VD1 is 0.5 V, and the VSWR characteristic designated by the code “a” is obtained when the reverse bias voltage of variable capacitance diode VD1 is 2.5 V.

By this means, as shown in the LowBand in FIG. 5, the resonant frequency of loop element 104 changes in the range of 470 to 570 MHz according to the receiving channel.

In summary, with the mobile telephone apparatus 100 according to the first embodiment, the resonant frequency of loop element 104 is set according to the currently received frequency, so that high receiving sensitivity is achieved over the entire range of the television broadcast frequency band.

Note that, in order to change the resonant frequency of loop element 104, band switching circuit 107 is preferably used together with voltage conversion by the voltage conversion circuit 121 as mentioned above, without using tuning voltage 119 directly. The reason is that if the frequency variation range associated with variable capacitance diode VD1 corresponds to a limited power supply voltage range (e.g., 3 V or less), the Q of variable capacitance diode VD1, and hence the antenna performance of loop element 104 would typically decrease.

It is needless to say that, if some performance degradation due to the decrease of the Q of variable capacitance diode VD1 pauses no problem, tuning voltage 119 may be input directly to variable tuning circuit 106 without using band switching circuit 107.

Furthermore, when the power supply voltage can be set high (e.g., about 10 V), the tuning voltage may be input to variable tuning circuit 106 after amplifying it with a constant amplification factor by voltage conversion circuit 121. In this case, the variation range of the reverse bias voltage of variable capacitance diode VD1 can be expanded more than the tuning voltage, so that the resonant frequency of loop element 104 can be changed over the entire frequency range without using band switching circuit 107.

In the present embodiment, although the tuning voltage is used to control variable tuning circuit 106, for example, channel control section 111 may generate a control voltage using a DA converter to control variable tuning circuit 106. In this case, control voltage values of variable tuning circuit 106 corresponding to received frequencies may be stored in a table in advance, and channel control section 111 may directly control the resonant frequency of loop element 104 according to the table.

In the present embodiment, although variable capacitance diode VD1 is used as a variable tuning means, any arrangement capable of changing the resonant frequency of loop element 104 may be employed.

In the present embodiment, although the resonant frequency of loop element 104 is switched using the capacitor C2 and the PIN diode D1 as a band switching means, any arrangement capable of changing the resonant frequency of loop element 104 stepwise by, for example, switching the loop length of loop element 104, may be employed.

Furthermore, a plurality of loop elements 104 with different loop lengths may be arranged as the band switching means, and the loop elements 104 may be switched stepwise according to the frequency band.

In the present embodiment, although the band switching means is configured to switch between two frequency bands (i.e., the HighBand and the LowBand), the band switch range of the band switching means may be divided into three or more bands.

In the present embodiment, although loop element 104 is built into upper case 101, loop element 104 may be arranged in any position that would not be covered with the hand of user 300 in state of use.

Furthermore, the orientation of loop element 104 is not limited to the one in mobile telephone apparatus 100 shown in the figures, the loop aperture plane may be positioned, for example, parallel to the longitudinal direction of mobile telephone apparatus 100. With such an arrangement, loop element 104 provides no gain for horizontally polarized waves but still provides an effect to reduce the influence near the human body.

Furthermore, although the effect in foldable mobile telephone apparatus 100 has been described above, it is needless to say that the similar effect can be provided in a straight-shaped mobile telephone apparatus that is not separated into an upper case 101 and a lower case 102.

### Second Embodiment

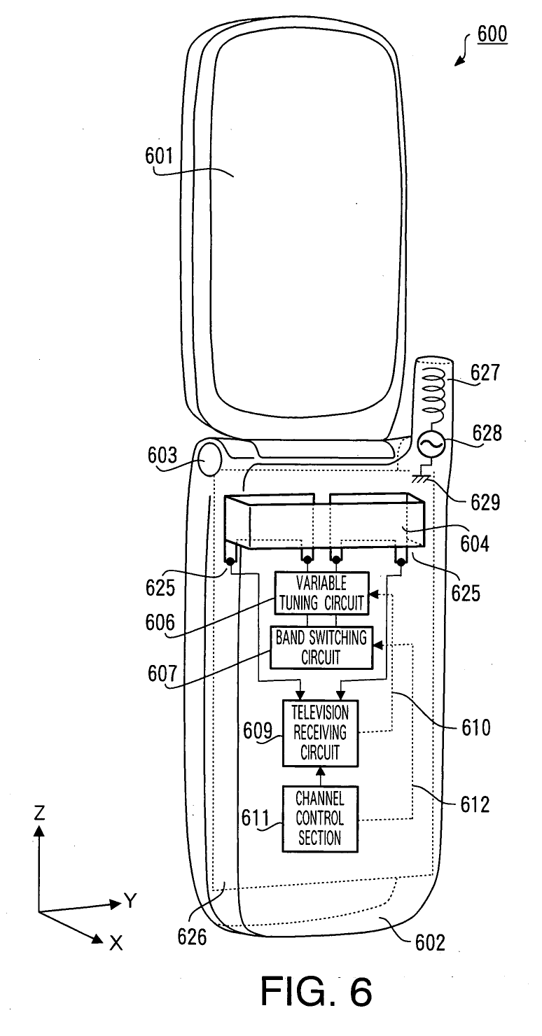

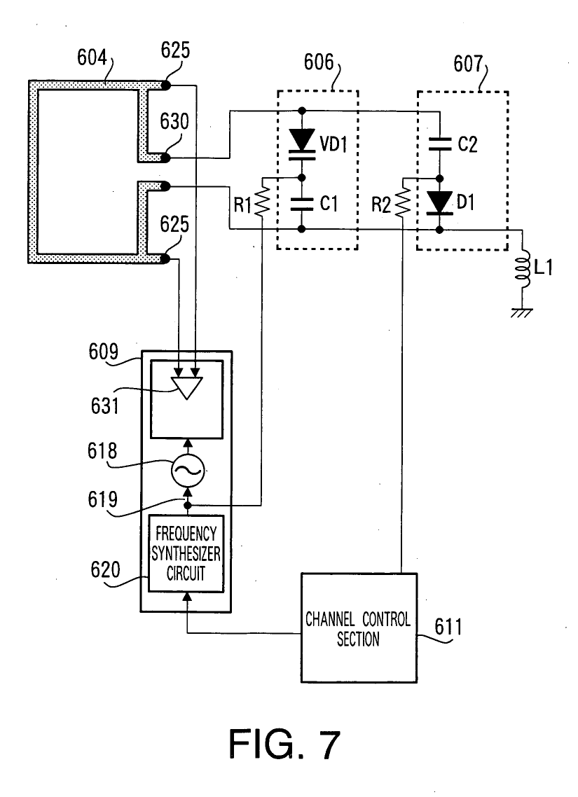

Next, the mobile telephone apparatus according to a second embodiment of the present invention will be described below with reference to FIGS. 6 and 7.

FIG. 6 shows a basic configuration of a mobile telephone apparatus according to a second embodiment of the present invention. FIG. 7 shows a variable tuning circuit and a band switching circuit of the mobile telephone apparatus according to the second embodiment of the present invention.

As shown in FIG. 6, mobile telephone apparatus 600 according to the second embodiment is composed of a foldable mobile telephone apparatus in which an upper case 601 and a lower case 602 are connected by hinge section 603 and are able to be opened and closed. Of course, the mobile telephone apparatus according to the present invention may be a straight-shaped mobile telephone apparatus comprised of one case.

Loop element 604 of mobile telephone apparatus 600 functions as a built-in television receiving antenna and is provided at the upper end of lower case 602 on the +X side in FIG. 6. As with the second embodiment, the loop aperture plane of loop element 604 is perpendicular to the plane of mobile telephone apparatus 600 and parallel to the width direction of mobile telephone apparatus 600.

The ends of loop element 604 are connected to variable tuning circuit 606 as a balanced, variable-tuning means and band switching circuit 607 as a band switching means. Neither of the two loop ends is connected to the ground of lower case 602.

The resonant frequency of loop element 604 is controlled by variable tuning circuit 606 and band switching circuit 607 within the range of about 470 to 700 MHz that are television broadcast frequencies.

Feed section 625 are provided at a predetermined distance (e.g., approximately 10 mm) away from the two loop ends of loop element 604. The impedance of loop element 604 is tapped such that the impedance between feed points 625 becomes, for example, 100 ohms.

Feed points 625 are connected to television receiving circuit 609, so that loop element 604 receives television waves. Television receiving circuit 609 is comprised of high frequency amplifier 631 to which a received television signal is input from feed points 625, local oscillation circuit 618 that determines the receiving frequency of high frequency amplifier 631, and frequency synthesizer circuit 620. Television receiving circuit 609 generates tuning voltage 610 and using it controls variable tuning circuit 606. Channel control section 611 sets the receiving channel of television receiving circuit 609 and controls band switching circuit 607 by band switching signal 612.

The loop aperture plane of loop element 604 configured in this way is perpendicular to the plane of mobile telephone apparatus 600, i.e., to circuit substrate 626. Furthermore, the loop aperture plane of loop element 604 is positioned parallel to the width direction (Y-axis direction in FIG. 6) of mobile telephone apparatus 600, i.e., the direction perpendicular to the longitudinal direction.

With mobile telephone apparatus 600 according to the second embodiment configured in the above manner, loop element 604 has emission characteristics where gain for horizontally polarized waves is obtained in the direction parallel to the width direction of mobile telephone apparatus 600, i.e., in the horizontal direction (Y-axis direction) in the arrangement shown in FIG. 6.

Mobile telephone apparatus 600 according to the second embodiment comprises helical antenna 627, which is a transmitting and receiving antenna for communication using mobile telephone apparatus 600. Helical antenna 627 is fed by feed section 628 with respect to ground section 629, which is connected to the ground potential of circuit substrate 626.

As a result, helical antenna 627 is fed unbalanced with respect to the ground of circuit substrate 626. Note that the main polarization direction of the transmitting and receiving antenna composed of helical antenna 627 and circuit substrate 626 is vertical (Z-axis direction in FIG. 6).

FIG. 7 shows an example of variable tuning circuit 606 and band switching circuit 607 of mobile telephone apparatus 600 according to the second embodiment. In FIG. 7, loop ends 630 of loop element 604 are open ends of a rounded loop. Variable tuning circuit 606 and band switching circuit 607 are connected to these loop ends 630 of loop element 604.

In FIG. 7, variable tuning circuit 106 and band switching circuit 107 shown in FIG. 4 are configured using balanced circuits. Variable tuning circuit 606 and band switching circuit 607 operate similar to variable tuning circuit 106 and band switching circuit 107 shown in FIG. 4, respectively. In FIG. 7, L1 represents a choke coil for a DC bias to a variable capacitance diode VD1 and PIN diode D1. This coil has no influence on the high frequency operation of the circuits.

Feed points 625 are connected to high frequency amplifier 631 that is the first stage of television receiving circuit 609, so that loop element 604 receives television waves. The high frequency amplifier 631 has a balanced input circuit.

When configured as mentioned above, loop element 604, variable tuning circuit 606, band switching circuit 607, and television receiving circuit 609 operate as a whole, as a balanced circuit. No current associated with the receiving operation for a television broadcast flows to the ground of circuit substrate 626 equipped with a radio communication circuit of mobile telephone apparatus 600 shown in FIG. 6. On the contrary, the current of the transmitting and receiving antenna composed of helical antenna 627 and circuit substrate 626 shown in FIG. 6 flows to the ground of circuit substrate 626.

Therefore, although the transmission current associated with a transmission operation of the radio communication circuit of this mobile telephone apparatus 600 flows to the ground of circuit substrate 626, this transmission current has no influence on television receiving circuit 609 due to the common-mode rejection operation because all the circuit elements composing the television receiving circuits are balanced circuits.

As a result, mobile telephone apparatus 600 according to the second embodiment ensures high receiving sensitivity to the television broadcast frequency and hence provides a stable receiving of a television broadcast even if mobile telephone apparatus 600 is communicating.

As described above, the mobile telephone apparatus of the present invention is capable of continuously changing the resonant frequency of the loop antenna element through the variable tuning means, and hence provides higher receiving sensitivity over a wide frequency range.

The mobile telephone apparatus of the present invention is capable of switching stepwise the resonant frequency of the loop antenna element through the band switching means, and hence provides higher receiving sensitivity over a wide frequency range.

The mobile telephone apparatus of the present invention is able to continuously change and/or switch stepwise the resonant frequency of the loop antenna element through the variable tuning means together with the band switching means, and hence provides higher receiving sensitivity over a wide frequency range.

The mobile telephone apparatus of the present invention is capable of continuously changing the resonant frequency of the loop antenna element by means of the variable tuning means through a tuning signal that sets the receiving channel of the broadcast receiving section, and hence provides high receiving sensitivity for all the receiving channels.

The mobile telephone apparatus of the present invention is capable of switching stepwise the resonant frequency of the loop antenna element by means of the band switching means through a band switching signal corresponding to the receiving channel of the broadcast receiving section, and hence provides higher receiving sensitivity for all the receiving channels.

The mobile telephone apparatus of the present invention is configured such that the loop antenna element and the signal input circuit of the broadcast receiving section are connected to each other using a balanced circuit in order to feed the loop antenna element, and hence provides high receiving sensitivity during transmission operation of the mobile telephone apparatus.

The mobile telephone apparatus of the present invention comprises a transmitting and receiving antenna for mobile telephone communications that is fed as an unbalanced antenna with respect to the ground of the circuit substrate, and hence provides high receiving sensitivity during transmission operation of the mobile telephone apparatus.

The mobile telephone apparatus of the present invention is configured such that the loop aperture plane of the loop antenna element is positioned orthogonal to the plane of the mobile telephone apparatus, and hence provides high receiving sensitivity when a user is holding the mobile telephone apparatus in his/her hand.

The mobile telephone apparatus of the present invention is configured such that the loop antenna element and the display section are respectively positioned in the opposite planes of the case, and hence provides high receiving sensitivity when a user is holding the mobile telephone apparatus in his/her hand.

This present application is based on Japanese patent application No. 2004-217903, filed on Jul. 26, 2004, the entire content of which is expressly incorporated herein by reference.

### INDUSTRIAL APPLICABILITY

The mobile telephone apparatus according to the present invention is advantageous in that the loop antenna element is built into the case such that the loop antenna element is not cumbersome when the mobile telephone apparatus is used, and high receiving sensitivity over a wide frequency range and the improved receiving performance can be provided even if the device is communicating when a user is holding the device in his/her hand and is viewing television broadcasting.

1. A mobile telephone apparatus, comprising:
a broadcast receiving section that receives broadcasting;
a loop antenna element built in a case of the mobile telephone apparatus; and
a frequency control section that controls a resonant frequency of the loop antenna element according to a current receiving channel.

2. The mobile telephone apparatus according to claim 1, wherein the frequency control section comprises a variable tuning section for continuously changing the resonant frequency of the loop antenna element.

3. The mobile telephone apparatus according to claim 1, wherein the frequency control section comprises a band switching section that switches the resonant frequency of the loop antenna element stepwise.

4. The mobile telephone apparatus according to claim 1, wherein the frequency control section controls the resonant frequency of the loop antenna element using a variable tuning section that continuously changes the resonant frequency of the loop antenna element together with a band switching section that switches the resonant frequency of the loop antenna element stepwise.

5. The mobile telephone apparatus according to claim 2, wherein the variable tuning section continuously changes the resonant frequency of the loop antenna element using a tuning signal that sets the receiving channel of the broadcast receiving section.

6. The mobile telephone apparatus according to claim 3, wherein the band switching section switches the resonant frequency of the loop antenna element stepwise using a band switching signal corresponding to the receiving channel information for the broadcast receiving section.

7. The mobile telephone apparatus according to claim 1, wherein the loop antenna element and a signal input circuit of the broadcast receiving section are connected using a balanced circuit to feed the loop antenna element.

8. The mobile telephone apparatus according to claim 7, further comprising a transmitting and receiving antenna for mobile telephone communications that is fed unbalanced with respect to a ground of a circuit substrate.

9. The mobile telephone apparatus according to claim 1, wherein a loop aperture plane of the loop element is provided perpendicular to a plane of the mobile telephone apparatus.

10. The mobile telephone apparatus according to claim 1, further comprising a display section that displays a television image, wherein the loop element is provided in a opposite plane to a plane where the display section is provided.
